(19) United States
(12) Patent Application Publication
(10) Pub. No.: US 2026/0028243 A1
(43) Pub. Date: Jan. 29, 2026

(54) METAL COMPOSITE HYDROXIDE AND METHOD FOR PRODUCING POSITIVE ELECTRODE ACTIVE MATERIAL FOR LITHIUM SECONDARY BATTERY

(71) Applicant: TANAKA CHEMICAL CORPORATION, Fukui (JP)

(72) Inventor: Ryota SAKAIDA, Fukui-shi (JP)

(21) Appl. No.: 18/994,201

(22) PCT Filed: Jul. 14, 2023
(86) PCT No.: PCT/JP2023/026156

§ 371 Date: Jan. 14, 2025

(30) Foreign Application Priority Data
Jul. 15, 2022 (JP) 2022-114311

(51) Int. Cl. C01G 53/504; H01M 10/052

(52) U.S. Cl. CPC C01G 53/504; C01P 2004/61; C01P 2006/12; C01P 2006/40; H01M 10/052

(57) ABSTRACT

The present invention relates to a metal composite hydroxide used as a precursor of a positive electrode active material for a lithium secondary battery, said metal composite hydroxide comprising at least one metal element selected from the group consisting of Ni, Co, and Mn, and satisfying all of the following requirements (1) to (4):
(1) An average particle strength is 10 MPa or more and less than 45 MPa;
(2) A molar ratio (Mn/Co) of manganese to cobalt is more than 1.0;
(3) A BET specific surface area is less than 40 m²/g;
(4) An average particle diameter D₅₀ is 4 μm or less.

### TECHNICAL FIELD

The present invention relates to a metal composite hydroxide and a method for producing a positive electrode active material for a lithium secondary battery.

Priority is claimed on Japanese Patent Application No. 2022-114311, filed Jul. 15, 2022, the content of which is incorporated herein by reference.

### BACKGROUND ART

As a method for producing a positive electrode active material for lithium secondary batteries, for example, there is a method of mixing a lithium compound and a metal composite compound containing a metal element other than Li, followed by calcination.

In order to improve the performance of lithium secondary batteries, the metal composite compound described above has been studied. For example, Patent Document 1 discloses a nickel-manganese-cobalt-containing composite hydroxide composed of secondary particles formed by aggregation of a plurality of plate-shaped primary particles and fine primary particles smaller than the plate-shaped primary particles, as a precursor of a positive electrode active material for lithium ion secondary batteries. It has been disclosed that a lithium ion secondary battery produced using a positive electrode active material for lithium ion secondary batteries having the above nickel-manganese-cobalt-containing composite hydroxide as a precursor exhibits high durability and excellent output characteristics.

### CITATION LIST

### Patent Document

Patent Document 1: Japanese Unexamined Patent Application, First Publication No. 2020-177860

### SUMMARY OF INVENTION

### Technical Problem

As the application fields of lithium secondary batteries develop, further improvements are required for the lithium secondary batteries in the initial efficiency.

The present invention has been made in view of the above circumstances, and aims to provide: a metal composite hydroxide used as a precursor of a positive electrode active material for lithium secondary batteries, from which a lithium secondary battery with high initial efficiency can be obtained; and a method for producing a positive electrode active material for a lithium secondary battery using the metal composite hydroxide.

### Solution to Problem

The present invention includes the following [1] to [4].

[1] A metal composite hydroxide used as a precursor of a positive electrode active material for a lithium secondary battery, said metal composite hydroxide including at least one metal element selected from the group consisting of Ni, Co, and Mn, and satisfying all of the following requirements (1) to (4):
(1) An average particle strength is 10 MPa or more and less than 45 MPa;
(2) A molar ratio (Mn/Co) of manganese to cobalt is more than 1.0;
(3) A BET specific surface area is less than 40 m²/g;
(4) An average particle diameter D₅₀ is 4 μm or less.

[2] The metal composite hydroxide according to [1], in which the metal composite hydroxide is represented by the following composition formula (I):

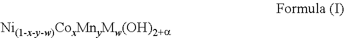

(said composition formula (I) satisfies 0<x<0.5, 0<y≤0.5, 0≤w≤0.5, x<y, 0<x+y+w<1, 0≤α, and M is one or more elements selected from the group consisting of Fe, Cu, Ti, Mg, Al, Zn, Sn, Zr, Nb, Ga, W, Mo, B, and Si.)

[3] The metal composite hydroxide according to [1] or [2], which has a standard deviation of particle strength of 2 MPa or more and 12 MPa or less.

[4] A method for producing a positive electrode active material for a lithium secondary battery,
the method comprising
a mixing step for mixing the metal composite hydroxide of any one of [1] to [3] with a lithium compound, and
a calcination step for calcining the obtained mixture at a temperature of 500° C. or higher and 1,000° C. or lower in an oxygen-containing atmosphere.

### Advantageous Effects of Invention

According to the present invention, it is possible to provide: a metal composite hydroxide used as a precursor of a positive electrode active material for lithium secondary batteries, from which a lithium secondary battery with high initial efficiency rate can be obtained; and a method for producing a positive electrode active material for a lithium secondary battery using the metal composite hydroxide.

### DESCRIPTION OF EMBODIMENTS

The definitions of terms used in the present specification are as follows.

A metal composite hydroxide is hereinafter also referred to as “MCH.”

A positive electrode (cathode) active material for lithium secondary batteries is hereinafter also referred to as “CAM.”

“Ni” indicates elemental Ni, not a simple substance of nickel metal. The same applies to the notations of other elements such as Co and Mn.

The term “primary particle” refers to a particle that does not have a grain boundary when observed at a visual field magnification of 10,000 times or more and 30,000 times or less using a scanning electron microscope or the like.

The term “secondary particle” refers to a particle formed by aggregation of the primary particles. In other words, secondary particles are aggregates of primary particles.

Regarding numerical ranges, “A or more and B or less” is expressed as “A to B”. For example, when a numerical range is described as “1 to 10 MPa,” it means a range from 1 MPa to 10 MPa, and refers to a numerical range including 1 MPa as the lower limit value and 10 MPa as the upper limit value.

The measurement methods for each parameter of the MCH in the present specification are as follows.

### (Average Particle Strength)

The average particle strength (unit: MPa) of the MCH can be measured and calculated as follows. First, 20 secondary particles are randomly selected from the MCH. Using a microcompression tester (for example, MCT-510 manufactured by Shimadzu Corporation), the particle diameter and particle strength of each of the selected secondary particles are measured. Here, the particle strength Cs (unit: MPa) can be determined by the following formula (A). In the following formula (A), P denotes the test force (unit: N) and d denotes the particle diameter (unit: mm). P is a pressure value at which the displacement becomes maximum while the test pressure remains almost constant when the test pressure is gradually increased. d is a value obtained by measuring the diameters in the X and Y directions in an image observed by the microcompression tester and calculating the average value thereof.

$$Cs = 2.8 P / π {d}^{2} \qquad ( A )$$

The average value of Cs of the 20 secondary particles obtained is the average particle strength.

Since particle strength is normalized by particle diameter, if the structure of each particle is the same, the particle strength will be the same (average particle strength±5%) even among particles having different particle diameters. On the other hand, if the particle strength differs between particles, it can be said that the structure of each particle is different.

### (Standard Deviation of Particle Strength)

The standard deviation of the particle strength of the MCH can be calculated from the average particle strength and the Cs of the 20 secondary particles obtained as described above in the section entitled (average particle strength).

### (Average Particle Diameter D₅₀)

The average particle diameter D₅₀ (unit: μm) of the MCH or CAM can be obtained from the particle size distribution of the MCH or CAM measured by a laser diffraction scattering method. More specifically, 0.1 g of an MCH or CAM powder is added into 50 mL of a 0.2% by mass aqueous solution of sodium hexametaphosphate to obtain a dispersion liquid in which the powder is dispersed. Next, the particle size distribution of the obtained dispersion liquid is measured using a laser diffraction scattering particle size distribution measuring device (for example, Microtrac MT3300EXII manufactured by MicrotracBEL Corporation) to obtain a volume-based cumulative particle size distribution curve. In the obtained cumulative particle size distribution curve, the particle diameter value at 50 cumulative percent from the fine particle side is the average particle diameter (hereinafter, sometimes referred to as D₅₀).

### (BET Specific Surface Area)

The BET specific surface area (unit: m²/g) of the MCH can be measured by the BET (Brunauer, Emmett, Teller) method. Nitrogen gas is used as an adsorption gas in measuring the BET specific surface area. For example, after drying 1 g of a measurement target powder in a nitrogen atmosphere at 105° C. for 30 minutes, measurement can be conducted using a BET specific surface area meter (for example, Macsorb (registered trademark) manufactured by Mountech Co., Ltd.).

### (Composition)

The composition of each metal element in MCH can be measured by inductively coupled plasma emission spectrometry (ICP). For example, after dissolving the MCH in hydrochloric acid, the amount of each metal element can be measured using an inductively coupled plasma optical emission spectrometer (for example, SPS3000, manufactured by SII Nano Technology Inc.).

The CAM evaluation method in the present specification is as follows.

### (Initial Efficiency)

A lithium secondary battery is produced using CAM by the method described in the Examples below. An initial efficiency test is performed using the produced lithium secondary battery by the following method, and the initial efficiency is calculated.

### —Initial Efficiency Test

The lithium secondary battery is left to stand at room temperature for 12 hours, thereby allowing the separator and positive electrode mixture layer to be sufficiently impregnated with the electrolytic solution.

Next, at a test temperature of 25° C., the current value for both charging and discharging is set to 0.2 CA, and constant current/constant voltage charging and constant current discharging are performed, respectively. The maximum charge voltage is set to 4.3 V, and the minimum discharge voltage is set to 2.5 V. The charge time is set to 6 hours, and the discharge time is set to 5 hours. Measure the charge capacity, and the value obtained is the “initial charge capacity” (mAh/g). Then measure the discharge capacity, and the value obtained is the “initial discharge capacity” (mAh/g).

The initial discharge capacity and initial charge capacity values are used to calculate the initial efficiency with the following formula.

$$Initial efficiency ( \% ) = Initial discharge capacity ( mAh / g ) / Initial charge capacity ( mAh / g ) \times 100$$

### <<Metal Composite Hydroxide>>

The MCH of the present embodiment can be used as a precursor of CAM. MCH contains at least one metal element selected from the group consisting of Ni, Co, and Mn, and satisfies all of the following requirements (1) to (4).

(1) The average particle strength is 10 MPa or more and less than 40 MPa.

(2) The molar ratio (Mn/Co) of manganese with respect to cobalt is more than 1.0.

(3) The BET specific surface area is less than 40 m²/g.

(4) The average particle diameter D₅₀ is 4.0 μm or less.

The MCH is an aggregate of a plurality of particles. In other words, the MCH is in a powder form. The aggregate of a plurality of particles may contain only secondary particles, or may be a mixture of primary particles and secondary particles.

### <Requirement (1)>

The average particle strength of the MCH is 10 MPa or more and less than 45 MPa. The average particle strength is 10 MPa or more, preferably 15 MPa or more, and more preferably 20 MPa or more. The average particle strength is less than 45 MPa, and preferably 44 MPa or less.

The above lower limit values and upper limit values can be arbitrarily combined.

For example, the average particle strength is preferably 15 to 44 MPa, and more preferably 20 to 44 MPa. When the average particle strength is within the above range, the resulting positive electrode for a lithium secondary battery is likely to have a suitable electrode structure, and as a result, the initial efficiency of the resulting lithium secondary battery is likely to be improved.

When CAM is produced from MCH, the average particle diameter of the particles may change significantly. Since a change in the average particle diameter has a significant effect on the particle design of CAM, it is also required that the average particle diameter of the particles does not change easily when CAM is produced from MCH. When the average particle strength is within the above range, the change in the average particle diameter is suppressed when CAM is produced from MCH.

The ratio of the D₅₀ of CAM with respect to the D₅₀ of MCH is preferably 0.8 or more, more preferably 0.9 or more, and still more preferably 1.0 or more. The ratio of the D₅₀ of CAM with respect to the D₅₀ of MCH is preferably 1.4 or less, more preferably 1.3 or less, and still more preferably 1.2 or less.

The lower limit values and the upper limit values can be arbitrarily combined.

For example, the ratio of the D₅₀ of CAM with respect to the D₅₀ of MCH is preferably 0.8 to 1.4, more preferably 0.9 to 1.3, and still more preferably 1.0 to 1.2.

An MCH that satisfies the requirement (1) is an MCH with low particle strength. It is considered that particle strength is determined by a plurality of factors related to the aggregation state of primary particles, such as the density of primary particles in the secondary particles, the orientation of primary particles, the contact area between primary particles, and the strength of adhesion between primary particles. Further, the above factors are also influenced by the characteristics derived from the primary particles, such as the size and shape of the primary particles. For example, it is considered that even among the MCH in which the density of primary particles in the secondary particles is low, depending on the other factors described above, the average particle strength of the MCH will be 45 MPa or more, which does not satisfy the above requirement (1).

As the primary particles, fully grown primary particles having an anisotropic shape are preferred. The phrase “anisotropic shape” refers to a shape obtained as a result of growth biased in the direction of at least one of the crystal axes a-axis, b-axis, and c-axis. Examples of anisotropic shapes include rod-like shapes that results from growth biased along one axis. When the primary particles grow sufficiently, the primary particles become relatively large. Large primary particles have a smaller external surface area per unit volume than small primary particles. Therefore, it is considered that the contact area between large primary particles is more likely to be smaller than that of small primary particles when the primary particles aggregate. In addition, it is considered that when the primary particles have an anisotropic shape, the density of the primary particles in the secondary particles is lower than that of primary particles having an isotropic shape. The phrase “isotropic shape” refers to a shape obtained as a result of relatively equal growth in the directions of the a-axis, b-axis, and c-axis crystal axes.

The aggregation state of primary particles in the secondary particles is preferably such that the density of the primary particles is low, the primary particles are uniformly oriented, the contact area between the primary particles is small, and the strength of adhesion between the primary particles is small. Such secondary particles tend to have low particle strength and are likely to satisfy the above requirement (1).

In addition, with regard to the aggregation state of primary particles in the secondary particles, the primary particles are preferably oriented in a uniform manner. In such a case, adjacent primary particles slide against each other, and the secondary particles tend to crack. Therefore, such secondary particles tend to have low particle strength and are likely to satisfy the above requirement (1).

The primary particles and the aggregation state of the primary particles in the secondary particles can be confirmed by observation with a scanning electron microscope.

### <Requirement (2)>

The molar ratio (hereinafter also referred to as “Mn/Co”) of manganese with respect to cobalt in MCH is more than 1.0, preferably 1.1 or more, and more preferably 1.2 or more. Mn/Co may be 4.0 or less, 3.0 or less, or 2.0 or less.

The above lower limit values and upper limit values can be arbitrarily combined.

Mn/Co is preferably more than 1.0 and 4.0 or less, more preferably 1.1 to 3.0, and still more preferably 1.2 to 2.0.

When Mn/Co is more than (or equal to) the lower limit, the amount of cobalt used, which is relatively expensive, relative to manganese, which is relatively inexpensive, can be reduced, which is economical. Furthermore, when Mn/Co is more than (or equal to) the lower limit, the initial efficiency of the resulting lithium secondary battery is likely to be improved. Furthermore, when Mn/Co is within the above range, changes in the average particle diameter are suppressed when CAM is produced from MCH.

### <Requirement (3)>

The BET specific surface area of the MCH is less than 40 m²/g, preferably 38 m²/g or less, more preferably 30 m²/g or less, and still more preferably 20 m²/g or less. The BET specific surface area may be 5 m²/g or more, 7 m²/g or more, or 9 m²/g or more.

The above lower limit values and upper limit values can be arbitrarily combined.

The BET specific surface area of MCH is preferably 5 m²/g or more and less than 40 m²/g, more preferably 5 to 38 m²/g, still more preferably 7 to 30 m²/g, and particularly preferably 9 to 20 m²/g.

When the BET specific surface area is equal to or more than the lower limit, the degree of crystallinity is prevented from becoming excessively high, making it easier to satisfy requirement (1). When the BET specific surface area is equal to or less than the upper limit, changes in the average particle diameter are suppressed when CAM is produced from MCH.

### <Requirement (4)>

D₅₀ of the MCH is 4.0 μm or less, preferably 1.0 to 4.0 μm, more preferably 1.5 to 4.0 μm, and still more preferably 2.0 to 4.0 μm.

When D₅₀ is equal to or greater than the lower limit of the range, an increase in the BET specific surface area can be suppressed during the production of CAM from MCH, and gas generation due to a side reaction with the electrolyte can be suppressed. When D₅₀ is equal to or less than the upper limit of the range, a change in the average particle diameter can be suppressed during the production of CAM from MCH.

In addition to the above requirements (1) to (4), the MCH preferably satisfies the following physical properties.

The standard deviation of particle strength of the MCH is preferably 2 to 12 MPa. The standard deviation is preferably 2 MPa or more, more preferably 3 MPa or more, and still more preferably 4 MPa or more. The standard deviation is preferably 12 MPa or less, and more preferably 11 MPa or less.

The above lower limit values and upper limit values can be arbitrarily combined.

For example, the standard deviation is more preferably 3 to 11 MPa, and still more preferably 4 to 11 MPa. When the standard deviation of particle strength is equal to or greater than the lower limit of the above range, particle cracking due to contact between particles is unlikely to occur, and handling properties are likely to be improved. When the standard deviation of particle strength is equal to or less than the upper limit of the above range, the uniformity of the precursor is high, and the cycle characteristics of a battery using the obtained CAM are likely to be improved.

The MCH of the present embodiment has a Mn/Co ratio of more than 1.0. It is known that MCH with a Mn/Co ratio of more than 1.0 is easily oxidized during the production of MCH, and the degree of crystallinity is accordingly reduced. In the MCH of the present embodiment, the degree of crystallinity is maintained high even when Mn/Co is more than 1.0 by optimizing the production conditions as described below. The inventors of the present application have found that when the degree of crystallinity of MCH with a Mn/Co ratio of more than 1.0 is high, the primary particles grow into a rod-like shape. As described above, when the primary particles have an anisotropic shape such as a rod-like shape, the density of the primary particles in the secondary particles is considered to be lower than that of primary particles having an isotropic shape. In the MCH of the present embodiment, the high degree of crystallinity is considered to be one of the factors that satisfy the requirement (1).

### <<Composition Formula>>

The MCH is preferably represented by the following composition formula (I).

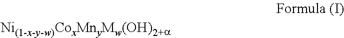

The above composition formula (I) satisfies 0<x<0.5, 0<y≤0.5, 0≤w≤0.5, x<y, 0<x+y+w<1, 0≤α, and M is one or more elements selected from the group consisting of Fe, Cu, Ti, Mg, Al, Zn, Sn, Zr, Nb, Ga, W, Mo, B, and Si.

When w is greater than 0, from the viewpoint that the cycle characteristics of a battery using the obtained CAM are likely to be improved, M is preferably one or more elements selected from the group consisting of Ti, Mg, Al, Zr, Nb, W, Mo, B, and Si, and more preferably one or more elements selected from the group consisting of Al, Zr, Nb, and W.

x is preferably 0.01 or more, more preferably 0.02 or more, and particularly preferably 0.03 or more.

x is preferably 0.44 or less, more preferably 0.42 or less, and particularly preferably 0.40 or less.

The above upper limit values and lower limit values of x can be arbitrarily combined.

The above composition formula (I) preferably satisfies 0.01≤x≤0.44, more preferably satisfies 0.02≤x≤0.42, and still more preferably satisfies 0.03≤x≤0.40.

y is preferably 0.02 or more, more preferably 0.03 or more, and particularly preferably 0.04 or more.

y is preferably 0.45 or less, more preferably 0.43 or less, and particularly preferably 0.41 or less.

The above upper limit values and lower limit values of y can be arbitrarily combined.

The above composition formula (I) preferably satisfies 0.02≤y≤0.45, more preferably satisfies 0.03≤y≤0.43, and still more preferably satisfies 0.04≤y≤0.41.

x+y+w is preferably 0.20 or more, more preferably 0.30 or more, and particularly preferably 0.40 or more.

x+y+w is preferably 0.70 or less, more preferably 0.66 or less, and particularly preferably 0.60 or less.

The above upper limit values and lower limit values of x+y+w can be arbitrarily combined.

The above composition formula (I) preferably satisfies 0≤α≤1.2. The a is appropriately adjusted depending on the chemical composition that the hydroxide of each metal element can have.

### <Method for Producing Metal Composite Hydroxide>

The method for producing an MCH of the present embodiment includes a reacting step in which a solution of a metal salt of Ni, a solution of a metal salt of Co, a solution of a metal salt of Mn, a complexing agent, and an alkaline solution are supplied to a reaction tank to carry out a coprecipitation reaction. MCH can be produced by a known batch coprecipitation method or a continuous coprecipitation method.

Hereinafter, a method for producing an MCH containing Ni, Co, and Mn will be described as an example. More specifically, a nickel salt solution, a cobalt salt solution, a manganese salt solution, a complexing agent, and an alkaline solution are reacted by the continuous coprecipitation method described in Japanese Unexamined Patent Application, First Publication No. 2002-201028 to produce an MCH represented by Ni_{(1-x′-y′)}Co_{x′}Mn_{y′}(OH)₂. For example, when producing an MCH represented by the above composition formula (I), x′ and y′ correspond to x and y in the above composition formula (I), respectively.

As a nickel salt serving as a solute of the nickel salt solution is not particularly limited, and for example, at least one of nickel sulfate, nickel nitrate, nickel chloride, and nickel acetate can be used.

As a cobalt salt serving as a solute of the cobalt salt solution, for example, at least one of cobalt sulfate, cobalt nitrate, cobalt chloride, and cobalt acetate can be used.

As a manganese salt serving as a solute of the manganese salt solution, for example, at least one of manganese sulfate, manganese nitrate, manganese chloride, and manganese acetate can be used.

It should be noted that even when producing an MCH containing a metal other than Ni, Co, and Mn, a sulfate, nitrate, chloride, or acetate of this metal can be used as the solute.

The metal salt is used in a ratio corresponding to the composition ratio of the above Ni_{(1-x′-y″)}Co_{x′}Mn_{y′}(OH)₂. That is, the amount of each metal salt is specified so that the molar ratio of Ni, Co, and Mn in a mixed solution containing the above metal salts corresponds to (1-x′-y′):x′:y′ in the above composition formula. Further, water is used as a solvent.

The complexing agent is capable of forming a complex with nickel ions, cobalt ions, and manganese ions in an aqueous solution, examples thereof include ammonium ion donors such as ammonium hydroxide, ammonium sulfate, ammonium chloride, ammonium carbonate, and ammonium fluoride, hydrazine, ethylenediaminetetraacetic acid, nitrilotriacetic acid, uracildiacetic acid, and glycine, and ammonium ion donors are preferred.

The amount of the complexing agent contained in a mixed solution containing the nickel salt solution, cobalt salt solution, manganese salt solution, and complexing agent is preferably such that, for example, the molar ratio with respect to the total number of moles of the metal salts (nickel salt, cobalt salt, and manganese salt) is greater than 0 and equal to or less than 2.0.

When an ammonium ion donor is used as the complexing agent, the ammonia concentration with respect to the total volume of the solution in the reaction tank is preferably from 0.8 to 3.9 g/L, more preferably from 1.0 to 3.9 g/L, and still more preferably from 1.0 to 3.0 g/L. When the ammonia concentration is within the above range, requirements (1) and (4) are easily satisfied.

In the coprecipitation method, in order to adjust the pH value of the mixed solution containing the nickel salt solution, cobalt salt solution, manganese salt solution, and complexing agent, an alkaline solution is added to the mixed solution before the pH of the mixed solution changes from alkaline to neutral. Examples of the alkaline solution include an aqueous solution of an alkali metal hydroxide. Further, examples of the alkali metal hydroxide include sodium hydroxide and potassium hydroxide.

It should be noted that the pH value in the present specification is defined as a value measured when the temperature of the mixed solution is 40° C. The pH of the mixed solution is measured when the temperature of the mixed solution sampled from the reaction tank reaches 40° C. When the sampled mixed solution is lower than 40° C., the mixed solution is heated to 40° C. and the pH is measured. When the sampled mixed solution is higher than 40° C., the mixed solution is cooled to 40° C. and the pH is measured.

When the complexing agent are continuously supplied to the reaction tank in addition to the above nickel salt solution, cobalt salt solution, manganese salt solution, Ni, Co, and Mn react to produce Ni_{(1-x′-y′)}CoₓMn_{y}(OH)₂.

The reaction temperature is preferably from 50 to 80° C., more preferably from 50 to 75° C., and still more preferably 65 to 75° C. When the reaction temperature is equal to or higher than the lower limit, MCH crystals tend to grow and the degree of crystallinity is improved, making it easier to satisfy the requirement (1). When the reaction temperature is equal to or lower than the upper limit, the reaction is easy to control.

The pH value of the solution in the reaction tank is preferably from 10.0 to 12.1, more preferably from 10.0 to 11.9, still more preferably from 11.5 to 11.9, and still more preferably from 11.5 to 11.8. When the pH is within the above range, the crystallinity and crystalline anisotropy of MCH are controlled, and as a result, the above requirement (1) is easily satisfied.

The reaction precipitate formed in the reaction tank is neutralized while being stirred. The time for neutralizing the reaction precipitate is, for example, from 1 to 24 hours.

As the reaction tank used in a continuous-type coprecipitation method, a type of reaction tank that overflows can be used in order to separate the formed reaction precipitate.

When producing an MCH by a batch-type coprecipitation method, examples of the reaction tank include a reaction tank without an overflow pipe, and a device equipped with a concentration tank connected to an overflow pipe and having a mechanism by which the overflowed reaction precipitate is concentrated in the concentration tank and circulated once again to the reaction tank.

It is preferable to supply a gas containing oxygen to the solution in the reaction tank. When a gas containing oxygen is supplied to the solution in the reaction tank, the primary particles grow while part of the MCH is oxidized. It is known that the primary particles of MCH generally grow isotropically, however, when the primary particles grow while part of the MCH is oxidized, the primary particles grow anisotropically. On the other hand, when too much oxygen is supplied, excessive oxidation proceeds and the crystallinity of the MCH decreases. The oxygen concentration with respect to the total volume of the gas containing oxygen is preferably 0.01 to 1.0 volume %. When the oxygen concentration is equal to or higher than the lower limit, the anisotropic growth of the primary particles is promoted. When the oxygen concentration is equal to or lower than the upper limit, the decrease in crystallinity is suppressed. As a result, it becomes easier to satisfy the requirement (1).

The temperature and pH in the reaction tank described above, the ammonia concentration with respect to the total volume of the solution in the reaction tank, and the oxygen concentration of the gas containing oxygen gas supplied to the solution in the reaction tank greatly affect the particle strength, BET specific surface area, and particle diameter of the resulting MCH. The effect is particularly large when the composition satisfies requirement (2). For this reason, it is preferable to appropriately adjust various conditions in order to satisfy requirements (1), (3), and (4). In particular, when the composition satisfies requirement (2), as described above, it is known that the crystallinity of MCH decreases. When the crystallinity decreases, it becomes particularly difficult to satisfy requirement (1). In the production method of the present embodiment, by optimizing various conditions, the crystallinity and anisotropy are maintained high even when the composition satisfies requirement (2), and as a result, requirement (1) is easily satisfied.

In the present embodiment, it is preferable that the reaction temperature is from 50 to 80° C., the pH is from 10.0 to 11.9, the ammonia concentration with respect to the total volume of the solution in the reaction tank is from 0.8 to 3.9 g/L, and the oxygen concentration of the gas containing oxygen gas supplied to the solution in the reaction tank is from 0.01 to 1.0% by volume, and it is even more preferable that the reaction temperature is from 65 to 75° C., the pH is from 11.5 to 11.8, the ammonia concentration with respect to the total volume of the solution in the reaction tank is from 1.0 to 3.0 g/L, and the oxygen concentration of the gas containing oxygen gas supplied to the solution in the reaction tank is from 0.02 to 0.05% by volume.

By using such reaction conditions, it becomes easier to obtain MCH that satisfies the above requirements (1), (3), and (4).

After the above reaction, the neutralized reaction precipitate is washed and then isolated. For the isolation, for example, a method of dehydrating a slurry containing the reaction precipitate (that is, a coprecipitated slurry) by centrifugation, suction filtration or the like is used.

The isolated reaction precipitate is washed, dehydrated, dried, and sieved to obtain an MCH containing Ni, Co, and Mn.

The reaction precipitate is preferably washed with water, weak acid water, or an alkaline cleaning solution. In the present embodiment, washing with an alkaline cleaning solution is preferred, and washing with an aqueous sodium hydroxide solution or an aqueous potassium hydroxide solution is more preferred.

It is preferable to wash with water, weak acid water, or an alkaline cleaning solution in a mass of 10 times or more the mass of the reaction precipitate. In addition, the temperature of the water, weak acid water, or alkaline cleaning solution used is preferably 30° C. or higher. Furthermore, it is preferable to perform washing one or more times.

It should be noted that after washing with a solution other than water, it is preferable to further wash with water so that compounds derived from the solution do not remain in the reaction precipitate.

The drying temperature is preferably from 80 to 250° C., and more preferably from 90 to 230° C. The drying time is preferably from 0.5 to 30 hours, and more preferably from 1 to 25 hours. The drying pressure may be normal pressure or reduced pressure.

By the steps described above, an MCH can be produced.

### <<Method for Producing Positive Electrode Active Material for Lithium Secondary Battery>>

The method for producing CAM includes a mixing step for mixing an MCH with a lithium compound, and a calcination step for calcining the obtained mixture at a temperature of 500° C. or higher and 1,000° C. or lower in an oxygen-containing atmosphere. CAM can be produced by the above method.

The above-mentioned MCH is used in the method for producing CAM.

### [Mixing Step]

The MCH and a lithium compound are mixed.

As the above lithium compound used in the present embodiment, at least any one of lithium carbonate, lithium nitrate, lithium acetate, lithium hydroxide (hydrates included), lithium oxide, lithium chloride, and lithium fluoride can be used. Among these, any one of lithium hydroxide and lithium carbonate, or a mixture thereof is preferred. Further, when the raw material (reagent or the like) containing lithium hydroxide contains lithium carbonate, the content of lithium carbonate in lithium hydroxide is preferably 5% by mass or less.

The lithium compound and the MCH are mixed in consideration of the composition ratio of the final target product, thereby obtaining a mixture of the lithium compound and the MCH. The amount of lithium with respect to the total amount (taken as 1) of metals contained in the MCH (molar ratio) is preferably from 0.98 to 1.20, more preferably from 1.04 to 1.10, and particularly preferably from 1.05 to 1.10.

### [Calcination Step]

The obtained mixture is calcined at a calcination temperature of 500° C. or higher and to 1,000° C. or lower in an oxygen-containing atmosphere. By calcining the mixture, the lithium metal composite oxide crystals grow.

The calcination temperature in the present specification refers to the temperature of the atmosphere in the calcination furnace, and means the maximum temperature of the holding temperature (maximum holding temperature).

When the calcination step includes a plurality of calcination stages, the calcination temperature means the temperature when heating at the maximum holding temperature in each calcination stage.

The calcination temperature is, for example, preferably from 650 to 900° C., more preferably from 680 to 850° C., and particularly preferably from 700° C. to 820° C. When the calcination temperature is equal to or higher than the lower limit value of the above range, a CAM having a strong crystal structure can be obtained. Further, when the calcination temperature is equal to or lower than the upper limit value of the above range, the volatilization of lithium on the particle surface of the CAM can be reduced.

The retention time in the calcination is preferably from 3 to 50 hours, and more preferably from 4 to 20 hours. When the retention time in the calcination is equal to or less than the upper limit value of the above range, the volatilization of lithium is suppressed, and the deterioration in battery performance is suppressed. When the retention time in the calcination is equal to or more than the lower limit value of the above range, the development of crystals is promoted, and the deterioration in battery performance is suppressed.

In the present embodiment, the rate of temperature increase until reaching the maximum holding temperature in the calcination step is preferably 80° C./hour or more, more preferably 100° C./hour or more, and particularly preferably 150° C./hour or more. The rate of temperature increase until reaching the maximum holding temperature in the heating step is calculated from the time ranging from the start of temperature increase up to a point reaching the holding temperature in the calcination device.

The calcination step preferably includes a plurality of calcination stages with different calcination temperatures. For example, it is preferable to include a first calcination stage and a second calcination stage in which calcination is performed at a higher temperature than that in the first calcination stage. Calcination stages with different calcination temperatures and calcination times may be further included.

Depending on the desired composition, as the calcination atmosphere, air, oxygen, nitrogen, argon, a mixed gas thereof or the like is used, and multiple calcination steps are carried out if necessary. The calcination atmosphere is preferably an oxygen-containing atmosphere.

The mixture of the MCH and the lithium compound may be calcined in the presence of an inert melting agent. The inert melting agent is added to such an extent that the initial capacity of the battery using the CAM is not impaired, and may remain in the calcination product. As the inert melting agent, for example, the inert melting agent described in WO 2019/177032A1 can be used.

The calcination device used at the time of calcination is not particularly limited, and may be, for example, a continuous calcination furnace or a fluidized calcination furnace. Examples of the continuous calcination furnace include a tunnel furnace and a roller hearth kiln. As a fluidized calcination furnace, a rotary kiln may be used.

CAM is obtained by calcining the mixture of the MCH and the lithium compound as described above.

The D₅₀ of the CAM is preferably 3.0 to 6.0 μm, more preferably 3.0 to 5.0 μm, and still more preferably 3.5 to 5.0 μm.

### EXAMPLES

The present invention will be described in more detail below with reference to Examples, but the present invention is not limited thereto.

### <Measurement of Various Parameters of MCH and CAM>

Measurements of various parameters of an MCH and a CAM produced by the method described below were performed using the measurement methods and the like as described above in the sections entitled (average particle strength), (standard deviation of particle strength), (average particle diameter D₅₀), (composition), and (BET specific surface area).

### <Production of Positive Electrode for Lithium Secondary Battery>

CAM obtained by the production method described below, a conductive material (acetylene black), and a binder (PVdF) were added and kneaded so as to obtain a composition of CAM:conductive material:binder=92:5:3 (mass ratio) to prepare a paste-like positive electrode mixture. N-methyl-2-pyrrolidone was used as an organic solvent at the time of preparing the positive electrode mixture.

The obtained positive electrode mixture was applied to a 40 μm thick Al foil that serves as a current collector and vacuum dried at 150° C. for 8 hours to obtain a positive electrode for a lithium secondary battery. The electrode area of this positive electrode for a lithium secondary battery was set to 1.65 cm².

### <Production of Lithium Secondary Battery (Coin-Type Half Cell)>

The following operations were performed in a glove box with an argon atmosphere.

The above-mentioned positive electrode for a lithium secondary battery was placed on a lower lid of a part for a coin-type battery R2032 (manufactured by Hohsen Corporation) with the aluminum foil surface facing down, and a laminate film separator (thickness: 16 μm) obtained by laminating a heat-resistant porous layer on a porous film made of polyethylene was placed thereon. 300 μl of an electrolytic solution was injected thereinto. As the electrolytic solution, a liquid obtained by dissolving LiPF₆ at a ratio of 1.0 mol/l in a mixed solution obtained by mixing ethylene carbonate, dimethyl carbonate, and ethyl methyl carbonate at a ratio of 30:35:35 (volume ratio) was used. Next, metallic lithium used as a negative electrode was placed on the upper side of the separator, covered with a top lid through a gasket, and swaged using a swage, thereby producing a lithium secondary battery (oin-type half cell R2032. Hereinafter, this may be referred to as “coin-type half cell.”).

### <Measurement of Initial Efficiency>

The initial discharge capacity and initial efficiency of the lithium secondary battery produced by the above method were measured using the measurement method described above under (initial efficiency), when the initial efficiency is more than 90.0%, it is evaluated as having a high initial efficiency.

### Example 1

After pouring water into a reaction tank equipped with a stirring device and an overflow pipe, an aqueous sodium hydroxide solution was added thereto, and the liquid temperature (reaction temperature) was maintained at 70° C.

An aqueous nickel sulfate solution, an aqueous cobalt sulfate solution, and an aqueous manganese sulfate solution were mixed so that the molar ratio of Ni:Co:Mn was 0.5:0.2:0.3 to prepare a mixed raw material solution 1.

The mixed raw material solution 1 and an aqueous ammonium sulfate solution as a complexing agent were continuously added into a reaction tank while stirring under continuous supply of oxygen-containing gas. An aqueous sodium hydroxide solution was added dropwise at appropriate times so that the pH of the mixed solution in the reaction tank became 11.8 (measurement temperature: 40° C.), and the rate of dropwise addition of the aqueous ammonium sulfate solution was adjusted so that the ammonia concentration became 2.5 g/L, thereby obtaining a reaction precipitate 1. It should be noted that the oxygen concentration with respect to the total volume of the oxygen-containing gas was set to 0.04% by volume.

The reaction precipitate 1 was washed using a 5% by mass aqueous sodium hydroxide solution in a mass 20 times the mass of the reaction precipitate 1. After washing, it was dehydrated in a centrifuge, washed with water, dehydrated, isolated, and dried at 105° C. for 20 hours to obtain an MCH 1 containing Ni, Co, and Mn. Various parameters of MCH 1 are shown in Table 1 (the same applies to Examples 2 and 3, and Comparative Examples 1 and 2 below). It should be noted that 1-x-y-w, x, y, and w in the composition column in Table 1 are values corresponding to those in the composition formula (I) described above.

Lithium carbonate was weighed out so that the amount of Li (molar ratio) with respect to the total amount (taken as 1) of Ni, Co, Mn contained in the MCH 1 was 1.07. The MCH 1 and the lithium carbonate were mixed to obtain a mixture 1.

Then, the obtained mixture 1 was calcined at 750° C. for 6 hours in an oxygen atmosphere to obtain a lithium metal composite oxide powder. The obtained powder was mixed with pure water adjusted to a liquid temperature of 5° C. so that the mass ratio of the above powder with respect to the total amount was 0.3 to prepare a slurry. The slurry was stirred for 20 minutes, then dehydrated, and further rinsed with pure water adjusted to a liquid temperature of 5° C. in an amount twice the mass of the above powder, followed by isolation and drying at 150° C. to obtain a CAM 1. Various parameters of CAM 1 are shown in Table 1 (the same applies to Examples 2 and 3, and Comparative Examples 1 and 2 below).

A lithium secondary battery was produced using the obtained CAM 1, and the initial efficiency was measured. The results are shown in Table 1 (the same applies to Examples 2 and 3 and Comparative Examples 1 and 2 below).

### Example 2

An MCH2 and a CAM2 were obtained in the same manner as in Example 1, except that the pH of the solution in the reaction tank during MCH production was 11.55 (measurement temperature: 40° C.) and the ammonium concentration in the tank was 1.1 g/L. A lithium secondary battery was produced using the obtained CAM 2, and the initial efficiency was measured.

### Example 3

An MCH 3 and a CAM 3 were obtained in the same manner as in Example 1, except that when MCH was produced, nickel sulfate aqueous solution, cobalt sulfate aqueous solution, manganese sulfate aqueous solution, and zirconium sulfate aqueous solution were mixed so that the molar ratio of Ni:Co:Mn:Zr was 0.548:0.199:0.248:0.005, the liquid temperature in the reaction tank was 50° C., the pH of the solution in the reaction tank was 11.94 (measurement temperature: 40° C.), and the ammonium concentration in the tank was 2.6 g/L. A lithium secondary battery was produced using the obtained CAM 3, and the initial efficiency was measured.

### Comparative Example 1

An MCH 4 and a CAM 4 were obtained in the same manner as in Example 1, except that the liquid temperature in the reaction tank during MCH production was 30° C., the pH in the reaction tank was 11.95 (measurement temperature: 40° C.), and the ammonium concentration in the tank was 4.0 g/L. A lithium secondary battery was produced using the obtained CAM 4, and the initial efficiency was measured.

### Comparative Example 2

An MCH 5 and a CAM 5 were obtained in the same manner as in Example 1, except that, when producing MCH, an aqueous nickel sulfate solution, an aqueous cobalt sulfate solution, and an aqueous manganese sulfate solution were mixed so that the molar ratio of Ni:Co:Mn was 0.6:0.2:0.2, the liquid temperature in the reaction tank was 60° C., the pH in the reaction tank was 12.2 (measurement temperature: 40° C.), and the ammonium concentration in the tank was 5.0 g/L.

A lithium secondary battery was produced using the obtained CAM 5, and the initial efficiency was measured.

TABLE 1

| | Parameters of MCH | | | | | | |
|---|---|---|---|---|---|---|---|
| | | | | | Average particle | Particle strength | |
| | Composition | | | | diameter | Average particle | Standard |
| | Ni | Co | Mn | M | D₅₀(MCH) | strength | deviation |
| | l-x-y-w | x | y | w | [μm] | [MPa] | [MPa] |
| Ex. 1 | 0.50 | 0.20 | 0.30 | 0.00 | 4.0 | 43.2 | 10.2 |
| Ex. 2 | 0.50 | 0.20 | 0.30 | 0.00 | 3.8 | 37.0 | 4.5 |
| Ex. 3 | 0.548 | 0.199 | 0.248 | 0.005 | 3.3 | 43.1 | 9.0 |
| Comp. Ex. 1 | 0.50 | 0.20 | 0.30 | 0.00 | 3.9 | 60.6 | 4.8 |
| Comp. Ex. 2 | 0.60 | 0.20 | 0.20 | 0.00 | 2.6 | 43.3 | 13.8 |

| | | Parameters of CAM | | |
|---|---|---|---|---|
| | Parameters of MCH | Average particle | | |
| | BET specific | diameter | | Battery characteristics |
| | surface area | D₅₀(CAM) | D₅₀(CAM)/ | Initial efficiency |
| | [m²/g] | [μm] | D₅₀(MCH) | [%] |
| Ex. 1 | 13.9 | 4.4 | 1.1 | 90.8 |
| Ex. 2 | 16.7 | 4.5 | 1.2 | 90.8 |
| Ex. 3 | 37.5 | 3.7 | 1.1 | 92.9 |
| Comp. Ex. 1 | 8.4 | 6.7 | 1.7 | 88.7 |
| Comp. Ex. 2 | 16.8 | 4.0 | 1.6 | 88.9 |

It was found that the lithium secondary batteries produced using the CAM having MCH as a precursors in Examples 1 to 3, which satisfy the requirements (1) to (4) had a high initial efficiency. In addition, in Examples 1 to 3, D₅₀(CAM)/D₅₀ (MCH) was within the range of 1.1 to 1.2, and it was found that the change in the average particle diameter was suppressed when CAM was produced from MCH.

1. A metal composite hydroxide used as a precursor of a positive electrode active material for a lithium secondary battery, said metal composite hydroxide comprising at least one metal element selected from the group consisting of Ni, Co, and Mn, and satisfying all of the following requirements (1) to (4):
(1) An average particle strength is 10 MPa or more and less than 45 MPa;
(2) A molar ratio (Mn/Co) of manganese to cobalt is more than 1.0;
(3) A BET specific surface area is less than 40 m²/g;
(4) An average particle diameter D₅₀ is 4 μm or less.

2. The metal composite hydroxide according to claim 1, wherein said metal composite hydroxide is represented by the following composition formula (I): 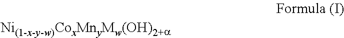
(said composition formula (I) satisfies 0<x<0.5, 0<y≤0.5, 0≤w≤0.5, x<y, 0<x+y+w<1, 0≤α, and M is one or more elements selected from the group consisting of Fe, Cu, Ti, Mg, Al, Zn, Sn, Zr, Nb, Ga, W, Mo, B, and Si.)

3. The metal composite hydroxide according to claim 1, which has a standard deviation of particle strength of 2 MPa or more and 12 MPa or less.

4. A method for producing a positive electrode active material for a lithium secondary battery,
the method comprising
a mixing step for mixing the metal composite hydroxide of claim 1 with a lithium compound, and
a calcination step for calcining the obtained mixture at a temperature of 500° C. or higher and 1,000° C. or lower in an oxygen-containing atmosphere.
